(19) United States
(12) Patent Application Publication
(10) Pub. No.: US 2026/0366540 A1
(43) Pub. Date: Nov. 19, 2026

(54) HIGH-TEMPERATURE MELT PUMP, AND HIGH-TEMPERATURE MELT PUMP SYSTEM

(71) Applicant: TEIRY CO., LTD., TAITO-KU, TOKYO (JP)

(72) Inventors: Nobuo ASO, TAITO-KU, TOKYO (JP); Sadatoshi SATO, TAITO-KU, TOKYO (JP)

(21) Appl. No.: 19/142,739

(22) PCT Filed: Jan. 15, 2024
(86) PCT No.: PCT/JP2024/000753

§ 371 Date: Jun. 24, 2025

(30) Foreign Application Priority Data
Jan. 18, 2023 (JP) 2023-005607

(51) Int. Cl. F04F 7/00; F04B 15/04; F04F 1/10; G21C 15/247

(52) U.S. Cl. CPC F04F 7/00; F04F 1/10; F04B 15/04; G21C 15/247

(57) ABSTRACT

The object of the present invention is to provide a technology for realizing a high-temperature melt pump that can be used in a device requiring the circulation of a high-temperature melt and that is more economical and practical. The high-temperature melt pump is a pump for transporting a fuel salt (10) within a pipe (15) in a predetermined direction, and includes the pipe (15); a plurality of fluid diodes (16) provided midway along the pipe (15), a pump main body container (7) which is connected to the pipe (15) and which is filled with a cover gas (17) that comes into contact with the fuel salt (10), and a gas vibration generating device (12) for transmitting vibrations to the fuel salt (10) in the pump main body container (7) by way of the cover gas (17).

### TECHNICAL FIELD

The present invention relates to a high-temperature melt pump and a high-temperature melt pump system.

### BACKGROUND ART

The following Patent Literature 1 discloses a technology related to a sodium pump used in fast reactors.

### CITATION LIST

### Patent Literature

Patent Literature 1: Japanese Patent Application Laid-Open No. H4-219476

### SUMMARY OF INVENTION

### Technical Problem

In devices that use molten salt, molten metal, or the like ((hereinafter, “high-temperature melt” includes high-temperature liquids other than molten salts and molten metals) as a coolant to transport heat or cool reactors, such as nuclear fusion reactors, molten salt reactors, and molten metal-cooled fast reactors, a pump for circulating the high-temperature melt (hereinafter, referred to as a “high-temperature melt pump”) is required.

A high-temperature melt pump must be able to transport extremely hot high-temperature melt at a certain flow rate or above, while also being equipped with a seal structure to prevent leakage of the high-temperature melt from the high-temperature melt pump and the cover gas inside the high-temperature melt pump, and must also be able to accommodate regular maintenance, so it is quite difficult to develop a high-temperature melt pump that can achieve the required performance.

The most common type of high-temperature melt pump is a turbo-type pump, such as a centrifugal pump or mixed-flow pump, which uses an impeller to transport the high-temperature melt, as used in the molten salt reactor experiment (MSRE) at Oak Ridge National Laboratory, as well as in the fast reactors like Joyo and Monju as a sodium pump.

Although bearings are essential for the shaft that rotates the impeller, considerable ingenuity is required to design a bearing system that functions stably in high-temperature environments and to design seals to prevent leakage of the high-temperature melt and the cover gas inside the high-temperature melt pump. Furthermore, the motor that rotates the shaft will not function properly at a high temperature, so the shaft length must be significantly longer or a special cooling system must be considered.

Regarding the bearing issue, MSRE uses ball bearings and an oil lubricant which also acts as a coolant. However, there is a problem in that a fuel salt becomes contaminated with the oil. While oil contamination may be tolerable in an experimental reactor that will only operate for around four years, it would be difficult to tolerate in a commercial reactor that will have to operate for decades or more.

On the other hand, the lower bearings in Joyo and Monju, which are immersed in liquid sodium, adopt fluid bearings that use liquid sodium as a lubricant. In fast reactors, since liquid sodium is used solely as a coolant, the risk of contamination by impurities is low, posing no particular issues, but in molten salt reactors, rare earth elements and rare metals as fission products are present within the molten salt. These fission products can precipitate and potentially damage the bearings, making the use of fluid bearings inappropriate.

When fluid bearings cannot be used, ceramic bearings or magnetic bearings are selected, but ceramic bearings have the problem of wear on the sliding parts, making it difficult to maintain stable operation for a long period of time. On the other hand, while magnetic bearings eliminate friction problems, the magnetic bearings rely on magnetic forces for support and thus cannot be used in high-temperature environments of 200 °C or higher. In order to use the magnetic bearings, cooling to below 200 °C is required.

Since the motor used to drive the impeller is also magnetically driven, there are very few products available that can operate in high-temperature environments of 200 °C or higher. Therefore, it is essential to design a motor section to be cooled to below 200 °C.

The high-temperature melt pump that is capable of solving the above-described problems and satisfying the required conditions has an extremely complicated structure. In order to cool a drive device such as a bearing or a motor, a shaft connecting an impeller directly in contact with a high-temperature melt and the drive device needs to be of a considerable length, and a shaft length of about 7 m is required in MONJU and about 5 m in Joyo.

A high-temperature melt pump with such a complicated structure also becomes extremely difficult to maintain, leading to various challenges in terms of both economic efficiency and practical applicability.

To solve these problems, a fundamental shift in thinking is required on how to realize a high-temperature melt pump that does not require any moving parts inside the pump, has a simple structure, and can be operated with almost no maintenance.

The present invention was developed in light of these circumstances, with the objective of providing a technology for realizing a high-temperature melt pump that can be used in a device requiring the circulation of a high-temperature melt and that is more economical and practical.

### Solution to Problem

In order to achieve the above object, in the high-temperature melt pump according to the present invention, a reciprocating volumetric pump similar to a piston pump or a diaphragm pump is adopted. In these reciprocating volumetric pumps, a piston or a diaphragm performs a reciprocating motion to transport a liquid. In a reciprocating volumetric pump, since the suction and discharge of a liquid are alternately repeated, a fluid diode is provided as a mechanism for transporting the liquid in a predetermined direction, as in a typical reciprocating volumetric pump.

However, in a typical reciprocating volumetric pump, a piston or a diaphragm comes into direct contact with a liquid. In the case of a diaphragm, there are no materials suitable for use with a high-temperature liquid like a high-temperature melt, and in the case of a piston, the sliding part functions similarly to a fluid bearing, which leads to the same problems encountered with a turbo-type pump when used in molten salt reactors. In addition, a piston drive device (motor or the like) is connected to the piston, the same problem of motor drive at a high temperature as in the case of the turbo-type pump described above occurs.

Therefore, in the present invention, instead of directly transporting the high-temperature melt by the reciprocating motion of the piston, the piston generates the reciprocating motion of a cover gas, the motion energy is transmitted to the high-temperature melt, and a motion of alternately repeating suction and discharge of the high-temperature melt is generated, thereby realizing the same function as a typical reciprocating volumetric pump. Since the piston is a device that generates a reciprocating motion of the cover gas, it is not always necessary to place the piston near the high-temperature melt, and the piston can be easily cooled, and various methods can be selected for the bearing mechanism of the piston sliding part.

Therefore, a high-temperature melt pump according to an aspect of the present invention is
a high-temperature melt pump that transports a high-temperature melt within a pipe in a predetermined direction, and is configured to include
the pipe,
a plurality of fluid diodes provided midway along the pipe,
a pump main body container configured to be connected to the pipe and filled with a cover gas that comes into contact with the high-temperature melt, and
a gas vibration generating device that transmits vibrations to the high-temperature melt in the pump main body container by way of the cover gas.

### Advantageous Effect of Invention

According to the present invention, it is possible to provide a technology for realizing a high-temperature melt pump that can be used in devices requiring the circulation of a high-temperature melt and that is more economical and practical.

### BRIEF DESCRIPTION OF DRAWINGS

FIG. 1 is a configuration diagram illustrating an example of a high-temperature melt pump and a high-temperature melt pump system according to the present invention.

FIG. 2 is an enlarged diagram of the high-temperature melt pump of FIG. 1.

FIG. 3 is an enlarged cross-sectional view of a Tesla valve which is an example of a fluid diode of FIG. 2.

FIG. 4 is a diagram illustrating an example of the transition of a vibration pressure in a gas vibration generating device that drives a piston by a triple eccentric mechanism of FIG. 1.

FIG. 5 is a diagram illustrating an example of the transition of a pump transportation amount in a pump main body of FIG. 1.

FIG. 6 is a diagram illustrating an example of the transition of a vibration pressure in the gas vibration generating device that drives the piston by a double cam mechanism instead of the triple eccentric mechanism of FIG. 1.

FIG. 7 is a diagram illustrating an example of the transition of a pump transportation amount in the pump main body when using the gas vibration generating device assumed in FIG. 6.

### DESCRIPTION OF EMBODIMENTS

Hereinafter, embodiments for carrying out the present invention will be described in detail with reference to the drawings.

It should be noted that the following description is merely an example, and the technical scope of the present invention is not limited thereto.

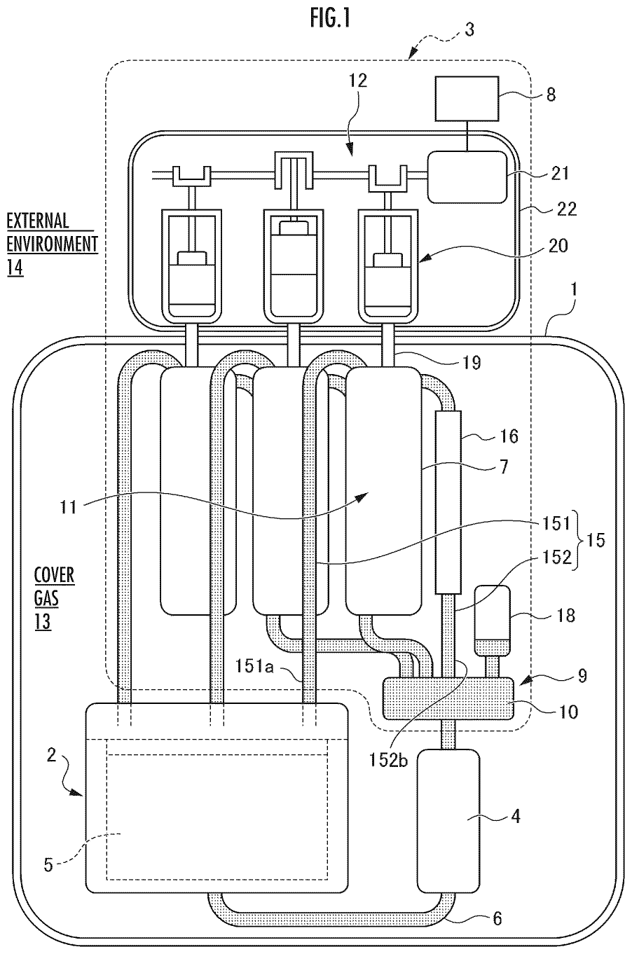

FIG. 1 is a configuration diagram illustrating an example of a high-temperature melt pump and a high-temperature melt pump system according to the present embodiment.

In the present example, a molten salt reactor plant will be described below as an example. It should be noted that the molten salt reactor plant is not limited. The present invention can also be applied and implemented in a nuclear fusion reactor, a fast reactor, or the like. In addition, the present invention can be applied and carried out, for example, in a solar thermal power generation system that uses molten salt when storing solar heat, a material manufacturing plant that uses a high-temperature melt, and the like.

### About Molten Salt Reactor Plant

A molten salt reactor plant illustrated in FIG. 1 is configured to include a storage container 1, a molten salt reactor 2 (reactor) surrounded by the storage container 1, a drain tank (not illustrated) surrounded by the storage container 1, a high-temperature melt pump system 3, a heat exchanger 4, and a pipe 6 that connects a reactor core 5 of the molten salt reactor 2 and the heat exchanger 4.

In the molten salt reactor plant, when a fuel salt 10 to be described later flows into the reactor core 5 of the molten salt reactor 2, a nuclear fission reaction occurs at that time, and thermal energy generated by the nuclear fission reaction is extracted through the heat exchanger 4. Then, the extracted thermal energy is converted into rotational energy, and is further converted into electrical energy by a generator so that power generation is performed.

The above-described heat exchanger 4 is provided to transfer thermal energy generated by the nuclear fission reaction to the cooling salt of a secondary loop. The high-temperature melt pump system 3 is provided to forcibly convect the fuel salt 10 described below. A pipe of the secondary loop through which the cooling salt flows is connected to the heat exchanger 4.

### About High-Temperature Melt Pump System 3

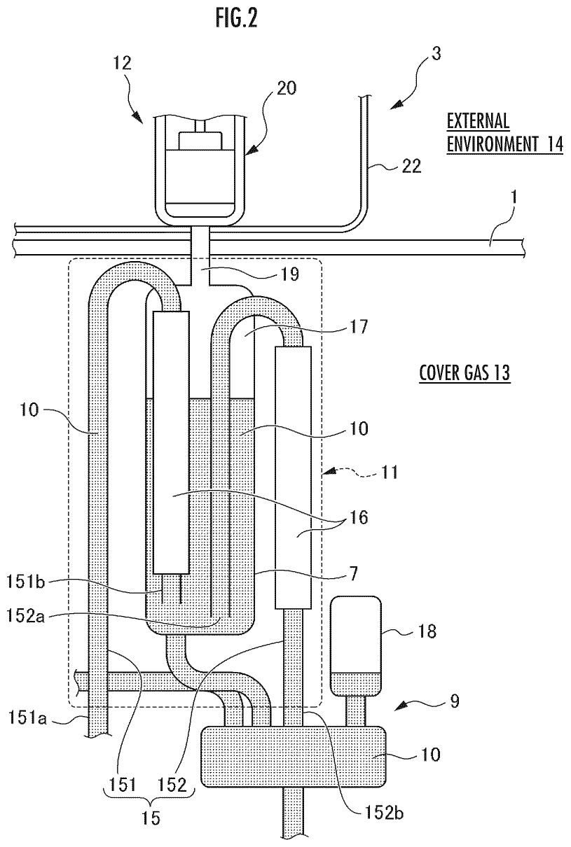

The high-temperature melt pump system 3 will be described with reference to FIGS. 1 and 2.

As described above, FIG. 1 is a configuration diagram illustrating an example of a high-temperature melt pump, a high-temperature melt pump system, and a reactor plant according to the present invention, and FIG. 2 is an enlarged diagram of the high-temperature melt pump of FIG. 1.

Such a high-temperature melt pump system 3 is configured to include a plurality of high-temperature melt pumps (in FIG. 1, an example of three pumps is illustrated, and a single high-temperature melt pump is illustrated in FIG. 2), a drive control device 8, and a pulsation adjusting device 9.

The high-temperature melt pump system 3 functions between the molten salt reactor 2 and the heat exchanger 4, and transports the fuel salt 10 in a direction from the molten salt reactor 2 to the heat exchanger 4.

### About High-Temperature Melt Pump

The high-temperature melt pump is mainly configured to include a pump main body 11 and a gas vibration generating device 12. In addition, the high-temperature melt pump includes the pulsation adjusting device 9 as necessary. In the high-temperature melt pump, the pump main body 11 is disposed inside the storage container 1, and the gas vibration generating device 12 is disposed outside the storage container 1.

In the example of use as a thorium molten salt reactor, the temperature of the cover gas 13 filled inside the storage container 1 is kept at about 500 °C, and a temperature of, for example, 100 °C or lower is assumed in the external environment 14 which is the outside of the storage container 1.

### About Pump Main Body 11

The pump main body 11 is configured to include a pipe 15, a fluid diode 16, and a pump main body container 7 in which the fuel salt 10 is held and with which a cover gas 17 is filled. The pump main body 11 is connected to the gas vibration generating device 12 via a pipe 19.

In FIG. 1, the pump main body 11 is illustrated to be located between the molten salt reactor 2 and the storage container 1, but the position of the pump main body 11 is not particularly limited to FIG. 1.

### About Pipe 15

The pipe 15 is configured to include a first pipe 151 on the upstream side and a second pipe 152 on the downstream side. A pipe upstream-side end portion 151a, which is one end portion of the first pipe 151, is connected to the upper portion of the molten salt reactor 2. In addition, the first pipe 151 is disposed such that the other end portion 151b is disposed inside the pump main body container 7.

Continuing the description with reference to the states illustrated in FIGS. 1 and 2, the first pipe 151 extends straight upward from the pipe upstream-side end portion 151a, makes a U-turn at the upper position of the pump main body container 7, and enters the inside of the pump main body container 7. Then, the other end portion 151b of the first pipe 151 is disposed on the lower inner side of the pump main body container 7. The fluid diode 16 is provided midway along the first pipe 151 on the other end portion 151b side.

One end portion 152a of the second pipe 152 is disposed at the lower inner side of the pump main body container 7. The one end portion 152a is disposed at a position lower than the other end portion 151b of the first pipe 151. The second pipe 152 extends straight upward from the one end portion 152a, makes a U-turn at the upper position of the pump main body container 7, and is drawn out to the outside of the pump main body container 7. The fluid diode 16 is provided midway along the second pipe 152 drawn out to the outside of the pump main body container 7.

A pipe downstream-side end portion 152b, which is the other end portion of the second pipe 152, is connected to the heat exchanger 4 via the pulsation adjusting device 9.

### About Fluid Diode 16

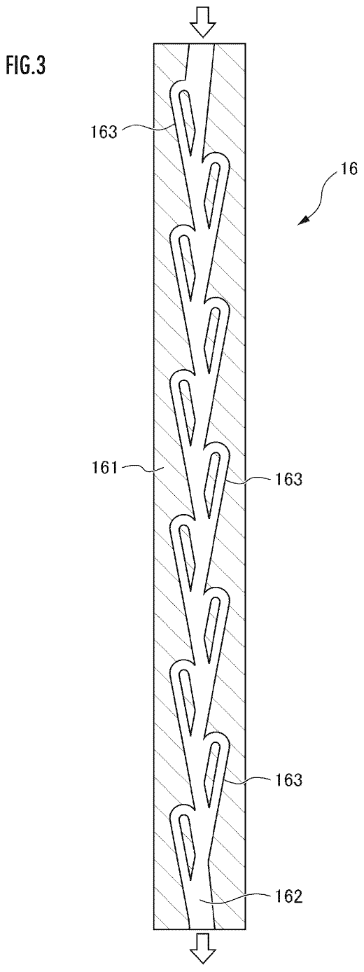

The fluid diode 16 will be described with reference to FIG. 3.

FIG. 3 is an example of an enlarged cross-sectional view of the fluid diode of FIGS. 1 and 2. In addition, FIGS. 1 and 2 will also be referred to as necessary.

The fluid diode 16 causes the fuel salt 10 to flow in a predetermined direction. That is, the fluid diode 16 has a function of allowing a liquid to flow in a predetermined direction but allowing no or only a small amount of the liquid to flow in the backward direction. Here, a “Tesla valve” or a “check valve” having a simple structure is adopted as the fluid diode 16.

FIG. 3 illustrates an example of a case where the fluid diode 16 is a “Tesla valve”, in which the fluid diode 16 is made of the same metal as the pipe 15, and a flow passage 162 is formed in the fluid diode main body 161. The flow passage 162 is formed in a shape in which a plurality of droplet-shaped loops 163 is connected. The flow passage 162 having such a shape has a function of smoothly flowing the fuel salt 10 in the forward direction, but has a function of inhibiting the flow in the backward direction.

The fluid diode 16 inside the pump main body container 7 is disposed so that the fuel salt 10 flows into the pump main body container 7, and the fluid diode 16 outside the pump main body container 7 is disposed so that the fuel salt 10 flows toward the heat exchanger 4.

### About Pump Main Body Container 7

As described above, the pump main body container 7 is a metal container in which the fuel salt 10 is held and with which the cover gas 17 is filled. In the pump main body container 7, the vibrations generated in the cover gas 17 that comes into contact with the fuel salt 10 are transmitted to the fuel salt 10. The vibrations are generated by the gas vibration generating device 12 described below.

### About Gas Vibration Generating Device 12

The gas vibration generating device 12 is a device for generating vibrations of the cover gas 17, and is configured to include a piston portion 20 having a piston and a motor 21 that moves the piston up and down. The gas vibration generating device 12 is controlled by the drive control device 8.

The piston portion 20 is configured to include a piston, a cylinder, a drive shaft, and a connecting rod. The piston portion 20 is surrounded by a metal container 22 with which the cover gas 17 is filled.

The drive unit (not illustrated) described above is a device that rotates a drive shaft of the piston portion 20, and is configured to include a motor, wiring, a power supply, and the like.

The gas vibration generating device 12 is not particularly limited as long as the gas vibration generating device 12 can generate vibrations of gas, other than the piston type described above.

### About Pulsation Adjusting Device 9

The pulsation adjusting device 9 is a tank (adjustment tank) for absorbing pulsation generated in the fuel salt 10 by allowing the fuel salt 10 before flowing into the heat exchanger 4 to flow into the pulsation adjusting device 9. The pulsation adjusting device 9 is a device that absorbs excessive pulsation by an air chamber 18 and the like.

### About Drive Control Device 8

The drive control device 8 is a device that manages and adjusts the occurrence status of the vibrations of each gas vibration generating device 12 of the plurality of high-temperature melt pumps.

The drive control device 8 is configured to include a central processing unit (CPU), a read only memory (ROM), a random access memory (RAM), an input/output unit, a storage unit, a communication unit, and an inverter or the like as necessary, and controls the drive of each gas vibration generating device 12 and controls the frequency of gas vibration and the like to control the pump transportation speed.

### About Operation of High-Temperature Melt Pump System 3

The vibrations generated by the cover gas 17 are transmitted to the fuel salt 10 that the cover gas 17 comes into contact with, and the fuel salt 10 flows from the upper portion of the molten salt reactor 2 through the first pipe 151 and the fluid diode 16, flows into the pump main body container 7, and then flows into the pulsation adjusting device 9 through the second pipe 152 and the fluid diode 16. Then, the fuel salt 10 after flowing into the heat exchanger 4 returns to the reactor core 5 from the lower portion of the molten salt reactor 2 through the pipe 6.

### About Elimination of Pulsation in High-Temperature Melt Pump System 3

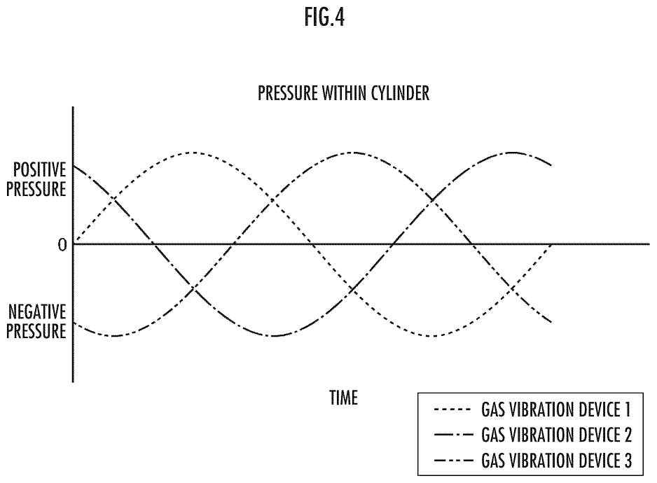

A method for eliminating the pulsation by the phase adjustment will be described with reference to FIGS. 4 to 7. FIGS. 1 to 3 will be referred to as necessary.

FIG. 4 is a diagram illustrating an example of the transition of a vibration pressure in the gas vibration generating device that drives the piston by the triple eccentric mechanism of FIG. 1.

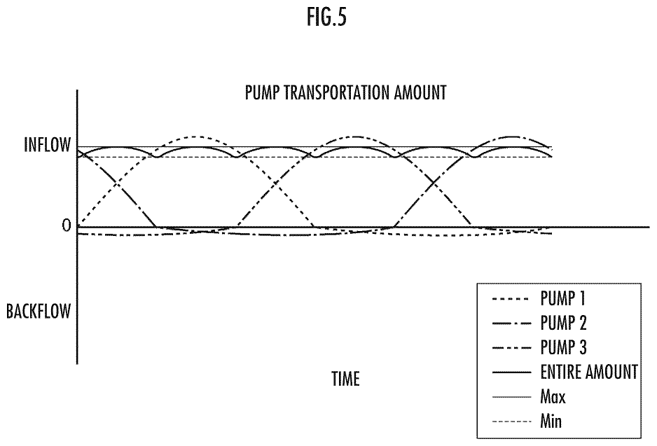

In addition, FIG. 5 is a diagram illustrating an example of the transition of a pump transportation amount in the pump main body of FIG. 1, and an entire transportation amount obtained by superimposing transportation amounts of three pumps is illustrated by a solid line. In the gas vibration generating device 12, the pistons are driven by an eccentric mechanism, and the three pistons move in a coupled manner while being shifted by one-third of a rotation so that the vibration pressures transit while drawing a sinusoidal curve, respectively.

As illustrated in FIG. 2, since a Tesla valve (fluid diode 16) is used in each pump, a large amount of the fuel salt 10 is transported when the vibration pressure from the gas vibration generating device 12 is a positive pressure, and a slight backflow of the fuel salt 10 occurs when the vibration pressure is a negative pressure. The pump transportation amounts from the three pump main bodies 11 overlap each other in a waveform as illustrated in FIG. 5 as a whole, and the pulsation of the pump transportation amount of the fuel salt 10 flowing into the pulsation adjusting device 9 is considerably reduced. In a theoretically calculated value, the proportion of the pulsation to the average pump transportation amount is about ±7%.

In the method using the three high-temperature melt pumps in series, the pulsation cannot be completely eliminated, but the pulsation can be further absorbed to a considerable extent by the pulsation adjusting device 9.

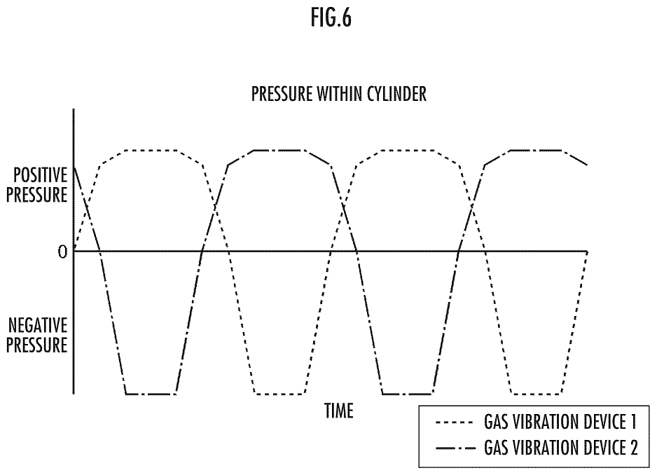

FIG. 6 is a diagram illustrating an example of the transition of a vibration pressure in a piston-driven gas vibration generating device using a double cam mechanism instead of the triple eccentric mechanism of FIG. 1.

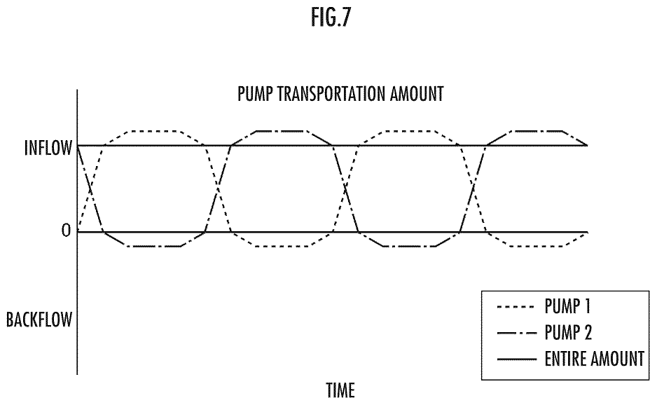

In addition, FIG. 7 is a diagram illustrating an example of the transition of a pump transportation amount in the pump main body when using the gas vibration generating device assumed in FIG. 6.

When it is necessary to substantially completely eliminate the pulsation, a method for generating the fluctuation of the vibration pressure as illustrated in FIG. 6 by using a piston-driven gas vibration generating device using a double cam mechanism instead of the triple eccentric mechanism of FIG. 1 can be considered. By incorporating the movement of the piston, which is such that the positive pressure equivalent to the backflow amount generated by using a Tesla valve (fluid diode 16) is added, into the cam, pulsation is almost completely eliminated in the entire pump transportation amount of the high-temperature melt transported from the two pump main bodies, as illustrated in FIG. 7. In the pulsation adjusting device 9 in this case, the air chamber 18 may not be particularly provided.

The pulsation elimination is not limited to the above-described method, and other methods for eliminating the pulsation can also be used.

### Effects

As described above with reference to FIGS. 1 to 7, the pump main body 11 in which the fuel salt 10 is held can provide a pump having an extremely simple structure, and particularly, when a Tesla valve is used as the fluid diode 16, the pump main body 11 can have an extremely simple structure with no moving parts.

Since the structure of the pump main body 11 is extremely simple, for example, it is possible to easily limit the cause of the failure, and it is possible to design the pump basically to be maintenance-free. In addition, since the maintenance target is only the gas vibration generating device 12 outside the storage container 1, the load of the maintenance can be significantly reduced.

As can be seen from the above-described configuration and structure, the high-temperature melt pump can extremely simplify the structure of the pump as compared with a known turbo-type pump. In particular, since the pump main body 11 is configured with only the pipe 15, the fluid diode 16, and the pump main body container 7, the number of components can be significantly reduced.

In the high-temperature melt pump, since the gas vibration generating device 12 is disposed outside the storage container 1, a cooling structure (not illustrated) can be simplified, and as a result, the number of components can be reduced.

From the above, it is possible to expect a considerable cost reduction in the high-temperature melt pump as compared with a turbo-type pump.

In the high-temperature melt pump, the gas vibration generating device 12 can be located at any position away from the pump main body 11 disposed inside the storage container 1. Therefore, cooling of a drive unit (not illustrated) of the gas vibration generating device 12 is easier than that of a known turbo-type pump, and as a result, it is possible to deal with a high-temperature melt at a considerably high temperature.

In addition, since the high-temperature melt pump has a structure that does not use a fluid bearing or the like, when a Tesla valve is used for the fluid diode 16, the high-temperature melt pump can be applied to a high-temperature melt in which fine solid substances are mixed, as long as the size of the high-temperature melt pump is considerably smaller than that of the flow passage 162.

### Summary

As described above with reference to FIGS. 1 to 7, it is possible to achieve an effect of providing a technology for realizing a high-temperature melt pump that can be used in a device requiring the circulation of a high-temperature melt and that is more economical and practical.

Although the embodiment and other embodiments of the present invention have been described, the present invention is not limited thereto. In addition, the effects described in the embodiments are merely a list of the most suitable effects obtained from the present invention, and the effects obtained from the present invention are not limited to those described in the embodiments.

The high-temperature melt pump to which the present invention is applied is sufficient with the following configuration, and various embodiments can be adopted.

That is, (1) a high-temperature melt pump to which the present invention is applied (for example, the high-temperature melt pump in FIG. 1) is
a high-temperature melt pump that transports a high-temperature melt (for example, the fuel salt 10 in FIG. 1) within a pipe (for example, the pipe 15 in FIG. 1) in a predetermined direction, and is configured to include
the pipe,
a plurality of fluid diodes (for example, the fluid diodes 16 in FIG. 1) provided midway along the pipe,
a pump main body container (for example, the pump main body container 7 in FIG. 1) configured to be connected to the pipe and filled with a cover gas (for example, the cover gas 17 in FIG. 1) that comes into contact with the high-temperature melt, and
a gas vibration generating device (for example, the gas vibration generating device 12 in FIG. 1) that transmits vibrations to the high-temperature melt in the pump main body container by way of the cover gas.

According to the present invention, it is possible to achieve an effect of realizing a high-temperature melt pump that can be used in a device requiring the circulation of a high-temperature melt and that is more economical and practical.

In addition, (2) a high-temperature melt pump system (for example, the high-temperature melt pump system 3 in FIG. 1) to which the present invention is applied is configured to include a plurality of high-temperature melt pumps according to (1), and a drive control device (for example, the drive control device 8 in FIG. 1) that adjusts a phase of vibrations generated by each gas vibration generating device of the plurality of high-temperature melt pumps.

According to the present invention, it is possible to achieve an effect of realizing a high-temperature melt pump system including a high-temperature melt pump that can be used in a device requiring the circulation of a high-temperature melt and that is more economical and practical.

In addition, (3) A high-temperature melt pump system to which the present invention is applied, further includes, in the high-temperature melt pump system according to (2), a pulsation adjusting device (for example, the pulsation adjusting device 9 in FIG. 1) disposed downstream of the pipe constituting the plurality of high-temperature melt pumps to absorb pulsation of the high-temperature melt to which the vibrations are transmitted. In addition, the high-temperature melt pump system further includes a method using a piston-driven gas vibration generating device using a double cam mechanism instead of the triple eccentric mechanism of FIG. 1.

According to the present invention, by disposing the pulsation adjusting device on the downstream side of the pipe or by installing the piston-driven gas vibration generating device using the double cam mechanism instead of the triple eccentric mechanism, it is possible to achieve an effect of absorbing the pulsation generated in the high-temperature melt.

### DESCRIPTION OF REFERENCE NUMERALS

1: storage container
2: molten salt reactor (reactor)
3: high-temperature melt pump system
4: heat exchanger
5: reactor core
6: pipe
7: pump main body container
8: drive control device
9: pulsation adjusting device
10: fuel salt
11: pump main body
12: gas vibration generating device
13: cover gas
14: external environment
15: pipe
151: first pipe
151a: pipe upstream-side end portion
151b: other end portion
152: second pipe
152a: one end portion
152b: pipe downstream-side end portion
16: fluid diode
161: fluid diode main body
162: flow passage
163: droplet-shaped loop
17: cover gas
18: air chamber
19: pipe
20: piston portion
21: motor
22: metal container

1. A high-temperature melt pump that transports a high-temperature melt within a pipe in a predetermined direction, the pump comprising:
the pipe;
a plurality of fluid diodes provided midway along the pipe;
a pump main body container configured to be connected to the pipe and filled with a cover gas that comes into contact with the high-temperature melt; and
a gas vibration generating device configured to transmit vibrations to the high-temperature melt in the pump main body container by way of reciprocating motion of the cover gas generated by reciprocating motion of a piston,
wherein the gas vibration generating device is disposed in external environment which is outside of a storage container in which the plurality of fluid diodes and the pump main body container are housed together with the pipe, the external environment being at a temperature lower than a temperature inside the storage container.

2. A high-temperature melt pump system comprising:
a plurality of the high-temperature melt pumps according to claim 1; and
a drive control device configured to adjust a phase of vibrations generated by each gas vibration generating device of the plurality of high-temperature melt pumps.

3. The high-temperature melt pump system according to claim 2, further comprising:
a pulsation adjusting device disposed downstream of a pipe constituting the plurality of high-temperature melt pumps to absorb pulsation of a high-temperature melt to which the vibrations are transmitted or a piston-driven gas vibration generating device using a double cam mechanism.

4. The high-temperature melt pump according to claim 1,
wherein at least one of the fluid diodes is provided outside of the pump main body container.

5. The high-temperature melt pump according to claim 4,
wherein the piston of the gas vibration generating device moves linearly up and down.

6. The high-temperature melt pump according to claim 1,
wherein the piston of the gas vibration generating device moves linearly up and down.
